(19) United States
(12) Patent Application Publication
(10) Pub. No.: US 2015/0322319 A1
(43) Pub. Date: Nov. 12, 2015

(54) Deicer and Method of Use

(71) Applicant: Jonathan Swanson, Ottawa (CA)

(72) Inventor: Jonathan Swanson, Ottawa (CA)

(21) Appl. No.: 14/491,910

(22) Filed: Sep. 19, 2014

(30) Foreign Application Priority Data
May 6, 2014 (CA) 2851032

(51) Int. Cl. C09K 3/18; B05D 3/12; B05D 3/04; B05D 1/02; B05D 3/02

(52) U.S. Cl. CPC C09K 3/185; B05D 1/02; B05D 3/0254; B05D 3/0406; B05D 3/12

(57) ABSTRACT

A deicer has Calcium Magnesium Acetate in a concentration greater than 25% by volume, leaving a remaining concentration, rock salt in the remaining concentration to form a mixture wherein water is added to the mixture such that the mixture dissolves in the water when the deicer is ready for use. A method of use for a deicer has the steps of adding water to a deicing mixture of Calcium Magnesium Acetate and rock salt, mixing the water and mixture such that the mixture dissolves in the water, to form a liquid deicer, and spreading the liquid deicer on ice. A deicing traction aid has a mixture comprising Calcium Magnesium Acetate in a concentration greater than 25% by volume, leaving a remaining concentration, rock salt in the remaining concentration, and a plurality of particles, wherein each particle is coated in the mixture.

### FIELD

The invention is in the field of deicing, and in particular Calcium Magnesium Acetate (CMA) deicers.

### BACKGROUND

Wintry conditions provide ice and snow, which cause problems on roads for cars and on sidewalks and walkways for pedestrians. Slipping and falling is a cause of significant injury annually for pedestrians, and when cars hit ice an accident will often occurs. Eliminating snow, frost and ice from roads is a priority during the winter season. In addition to plowing and shovelling snow, chemical deicers are used to melt snow and prevent the formation of ice.

Sand and crushed rock provides immediate traction aid when spread over an icy surface. The sand digs into the ice and becomes the surface on which the pedestrian or car moves. Sand has the advantage of attracting the sun's rays and warming the surrounding ice, thereby having a moderate deicing effect. It is also less harmful to the environment and infrastructure than alternative such as rock salt. In addition, sand is the preferred traction aid below −10° C. as chemical deicers cease to operate effectively in extreme cold.

Currently, there are two forms of chemical deicers: solid and liquid. Solid deicers, such as rock salts of Sodium Chloride (slat, or NaCl), Calcium Chloride (CaCl₂) and Magnesium Chloride (MgCl₂) (collectively “rock salts”) are commonly used to control snow and ice formation on roadways, highways and sidewalks. These rock salts dissolve into the snow to lower the freezing point of water, causing salt to melt at temperatures down to approximately −10° C. This reaction depresses the freezing point of water, thereby melting ice and snow instantaneously. Significant advantages include their immediate effectiveness in melting ice and snow and their low cost. They also provide some traction aid when distributed in significant quantities over the icy surface.

Significant drawbacks also exist in damage to infrastructure, particularly rebar within concrete, as well as premature rusting of cars and environmental degradation including salination of the water table.

Solutions of these rocks salts are extremely corrosive especially to iron alloys found, for example, in bridges and automobiles. Furthermore, the corrosive action of chlorides such as Sodium Chloride and Calcium Chloride have a negative impact on the environment such as harm to roadside trees, and the pollution of underground water.

In particular, at present, Calcium Magnesium Acetates (CMAs) are useful substitutionary deicers. CMAs are essentially not toxic and biologically decompose into carbon dioxide. CMAs cause an exothermic reaction when dissolved in water, similarly to Sodium Chloride or Calcium Chloride, to immediately melt snow, and furthermore CMA prevents the adherence of snow particles to each other and the road surface. CMA has a greater residual effect and last for approximately 2 weeks after application, as opposed to salt which washes away quickly. CMA exhibits very low corrosion rates on metals found on bridges, roadways and parking garages, commonly being described as being as corrosive as tap water. CMAs are less environmentally harmful than rock salts, for example they are non-toxic to humans and not harmful to roadside vegetation.

However, CMAs are relatively more expensive than rock salts. Further, they do not work on contact, rather they start to work only once mixed within the ice and/or snow, usually about 15-30 minutes after application, therefore they work better to prevent re-icing than as an ice remover. CMAs do not improve traction over the icy surface, so benefits to CMAs accrue only after they have been in place on the icy surface for some time.

Therefore there is a need for a de-icer that provides traction, immediate de-icing but also prevents the formation of ice in the future.

### SUMMARY

A deicer comprising has Calcium Magnesium Acetate in a concentration greater than 25% by volume, leaving a remaining concentration, rock salt in the remaining concentration to form a mixture wherein water is added to the mixture such that the mixture dissolves in the water when the deicer is ready for use.

In an embodiment calcium magnesium acetate is present in a concentration of 40%, and the rock salt may be calcium chloride or sodium chloride. The mixture may be shipped dry and the water is added at a destination.

A method of use for a deicer has the steps of adding water to a deicing mixture of Calcium Magnesium Acetate and rock salt, mixing the water and mixture such that the mixture dissolves in the water, to form a liquid deicer, and spreading the liquid deicer on ice.

The method may have the further step of waiting for the liquid deicer to settle before spreading the liquid deicer on ice. The deicer may continue to deice on a surface after application.

A deicing traction aid has a mixture comprising Calcium Magnesium Acetate in a concentration greater than 25% by volume, leaving a remaining concentration, rock salt in the remaining concentration, and a plurality of particles, wherein each particle is coated in the mixture.

The particles may be selected from the group consisting of sand, quartz, rock and stone. Once deposited on the ground, the mixture separates from the particles to deice adjacent surfaces. The particles may attracts solar heat to assist the mixture in deicing.

A method of manufacturing a deicing traction aid, comprising the steps of passing particles through a screener to screen dirt, dust and very small particles out, spreading the particles on a conveyor belt, passing the particles through a liquid spray of a mixture comprising Calcium Magnesium Acetate in a concentration greater than 25% by volume, leaving a remaining concentration; and rock salt in the remaining concentration, coating the particles with the mixture to form a product, and drying the product.

The method may have the further step of inspecting the particles for quality. Drying the product may have the step of shaking the product to even the coating and start the drying process, and/or the step of dropping the product to dry it. Drying the product may also have the further step of applying heat to the product. In the manufacture, the amount of coating is adjusted so it adheres to the particles. The method may also have the step of weighing and packaging the product.

### DESCRIPTION OF FIGURES

FIG. 1 shows a process of preparing the liquid deicer for use; and

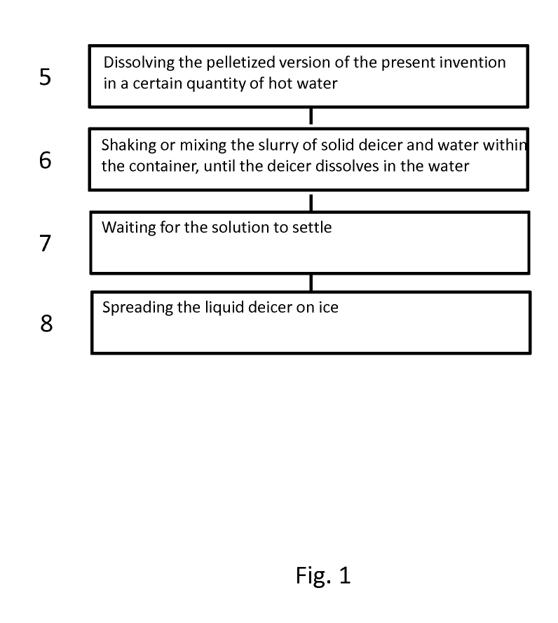

FIG. 2 shows a method of manufacturing a deicer having sand or rock particles therein.

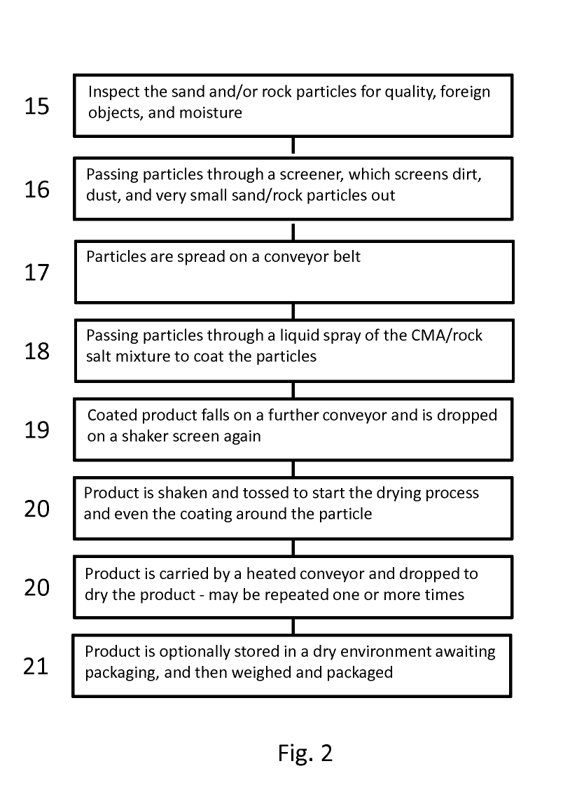

### DETAILED DESCRIPTION

An object of the present invention is to provide a composition for a low corrosive CMA based liquid deicer, and more particularly to a composition for a low corrosive liquid deicer, having approximately 60% by weight chloride (Sodium, Magnesium, or Calcium) and approximately 40% by weight solid CMA, which can replace solid snow removing agents and reduce corrosiveness and environmental problems. The present invention further relates to a process of preparing the deicer. Finally, the present invention relates to the use of a combination of sand for providing immediate traction aid and improving the efficiency of the said deicing composition.

When CMA is mixed with Sodium Chloride (salt) or Calcium Chloride at a minimum of 25% by weight, salt's naturally corrosive properties are inhibited by the CMA balancing the pH of the salt. Generally speaking, the more CMA in the blend, the more corrosion inhibition. Further, greater CMA concentration results in less environmental harm as CMA is less environmentally harmful than rock salt. Further, the greater the concentration of CMA the greater the residual ice-formation inhibition of the CMA. However, too great of a CMA concentration results in less immediate melting, and far higher production cost. Through experimentation, it has been determined that the optimum mixture of CMA to rock salt is 40% CMA to 60% rocks salt. In a preferred embodiment, the mixture is 40% CMA to 60% Calcium Chloride.

Potassium acetate may be used in addition to CMA for a lower melting point of approximately −45 degrees Celsius, and therefore a lower operating temperature. The combination of CMA, Calcium Chloride and Potassium Acetate will enable rapid deicing to −76 degrees Celsius over Sodium Chloride. In addition, due to the balanced pH resulting from the CMA in the mixture, the mixture will not cause corrosion at a greater rate than water alone.

By combining the ice melting effect of chlorides, with the acetate-based CMA, the present invention allows for both immediate and residual actions. The exothermic properties of rock salts will immediately start the ice melting process, while the CMA will interfere in the ability of snow particles to adhere to each other or to the pavement. The prevention of re-icing by the CMA ingredients lasts for a further 2-3 weeks to prevent the reformation of ice.

A liquid CMA-based deicer is more costly to produce than conventional rock salt deicers. However, liquid deicers have the benefit of penetrating ice and snow to melt within the ice, rather than sitting on the top of the ice surface. Further, liquid deicers are easier to spread than solid deicers, which may clump and be spread unevenly. It is natural to assume that a liquid deicer would melt ice slightly more effectively than a dry deicer, due to any warmth held by the liquid. However, the deicing ability of a liquid deicer is surprisingly better than that of a solid deicer due to the penetrative ability of the liquid deicer and the ability to spread the deicer, in addition to any heat held within the liquid of the deicer.

The present invention is produced in pellets, which are then mixed with hot water on site to produce a liquid CMA/rock salt mixture. The mixture is shipped dry and the water is added at a destination. This has the benefit of reduced shipping costs due to lower shipping weight. Further, the solid form of CMA/rock salt provides increased product stability for long-term bulk storage.

A process of preparing for use the liquid deicer having the above composition is in step 5 to dissolve the pelletized version of the present invention in a certain quantity of hot water, in step 6 shaking or mixing the slurry of solid deicer and water within the container, until the deicer dissolves in the water, in step 7 optionally waiting for the solution to settle, and in step 8 spreading the liquid deicer on ice. The liquid deicer solution will produce foam or bubbles but settle in time (approximately 10 minutes) and will be ready to use.

The freezing point of the deicer of the invention is −21 degrees Celsius, and for practical purposes the deicer is inactive below a temperature of −10° C. However, the deicer of the invention will remain dormant where applied until warmer temperatures occur, at which point it will activate and resume its liquid form to penetrate the ice. The present invention provides a low corrosive non-chloride based liquid deicer with low corrosive capabilities, and does not have toxicity to vegetation or underground waterways. In liquid form, the deicer of the invention will melt a thin layer of ice instantly and will prevent the formation of ice for up to two weeks. For thicker layers of ice, a combination of both conventional rock salts and liquid form of deicer of the invention will create an exothermic reaction six times higher than conventional rock salts.

In a further embodiment, the CMA/rock salt mixture may be used to coat sand particles or rock pellets. This provides an immediate benefit when the temperature reaches −10° C. or below, as the sand will provide traction while the CMA and rock salt are dormant. Once distributed, the CMA/rock salt mixture will come off the sand particles and work to melt and prevent reicing of the ice on which they are deposited. The CMA/rock slat mixture will be deposited adjacent to the sand or crushed stone particle from which it comes off. The sand particles provide traction in ice conditions as it digs into the ice, and the crushed particulate nature of the mixture serves to distribute the CMA/rock salt mixture evenly and avoids clumping. In addition, the presence of the sand particles attract solar energy due to their darker color and create localized heat, to melt nearby snow and assist the operation of the CMA and rock salt, which was deposited adjacent to the sand or rock particle. This assists in activating the CMA or rock salt, which must be within its effective temperature range to operate effectively.

A method of manufacture for the particles coated with the CMA/rock salt mixture is in step 15, to optionally inspect the sand and/or rock particles for quality and foreign objects, and ensure the particles are dry. In step 16 the particles are passed through a screener, which screens dirt, dust, and very small sand/rock particles out. In step 17 the remaining particles are spread on a conveyor belt. In step 18 they pass through a liquid spray of the CMA/rock salt mixture to coat the particles. The volume of coating is adjusted so the coating adheres to the particles to form product, but particles are not too wet. In step 19 the coated product falls on a further conveyor and is dropped on a shaker screen again. It is rapidly shaken and tossed to start the drying process and even the coating around the particle. In an embodiment, in step 20 the product is carried by a heated conveyor and dropped to dry the product. This drying step may be repeated one or more times. In an embodiment, the conveyor is heated by the sun, and in another a heat source may be used to heat the product's environment and dry the product. In step 21 the product is optionally stored in a dry environment awaiting packaging, and then weighed and packaged.

The product must remain dry or it may clump. In order to keep the product dry, some solid CMA/rock salt mixture, without sand/rock particles, may be added to the product to absorb moisture and prevent clumping. The addition of the solid CMA/rock salt also has additional deicing benefits, when compared with other moisture absorbent materials to prevent clumping known in the art.

In another embodiment, the mixture used to coat the sand/rock particles is 40% potassium acetate and 60% rock salts. In a preferred embodiment, the rock salt is Calcium Chloride.

The deicer separates from, and lies adjacent to, the sand and/or rock particles when the product is spread over an icy surface, by moisture of the ice or by mechanical means, such as being stepped on by passers-by. The blend of the deicer of the invention with sand or crushed rock provides an additional solution when the temperature reaches −10 degrees Celsius or below, giving traction in slippery ice conditions while the deicer of the invention remains dormant until it is activated by warmer temperatures. Additionally, the sand and crushed stone particles absorb solar radiation and increase the temperature in a localized area around the stone, activating adjacent deicer.

1. A deicer comprising:
a. Calcium Magnesium Acetate in a concentration greater than 25% by volume, leaving a remaining concentration;
b. rock salt in the remaining concentration to form a mixture
wherein water is added to the mixture such that the mixture dissolves in the water when the deicer is ready for use.

2. The liquid deicer of claim 1 wherein calcium magnesium acetate is present in a concentration of 40%.

3. The liquid deicer of claim 1 wherein the rock salt is calcium chloride.

4. The liquid deicer of claim 1 wherein the rock salt is sodium chloride.

5. The liquid deicer of claim 1 wherein the mixture is shipped dry and the water is added at a destination.

6. The deicer of claim 1 wherein the deicer is spread onto ice.

7. The deicer of claim 6 wherein the liquid deicer settles before the liquid deicer is spread onto ice.

8. The deicer of claim 6 wherein the deicer continues to deice on a surface after application.

9. A deicing traction aid comprising:
a. a mixture comprising:
i. Calcium Magnesium Acetate in a concentration greater than 25% by volume, leaving a remaining concentration; and
ii. rock salt in the remaining concentration; and
b. a plurality of particles
wherein each particle is coated in the mixture.

10. The deicing traction aid of claim 9 wherein the particles are selected from the group consisting of sand, quartz, rock and stone.

11. The deicing traction aid of claim 9 wherein once deposited on the ground, the mixture separates from the particles to deice adjacent surfaces.

12. The deicing traction aid of claim 10 wherein the particles attracts solar heat to assist the mixture in deicing.

13. A method of manufacturing a deicing traction aid, comprising the steps of:
a. passing particles through a screener to screen dirt, dust and very small particles out;
b. spreading the particles on a conveyor belt
c. passing the particles through a liquid spray of a mixture comprising Calcium Magnesium Acetate in a concentration greater than 25% by volume, leaving a remaining concentration; and rock salt in the remaining concentration;
d. coating the particles with the mixture to form a product; and
e. drying the product.

14. The method of manufacturing a deicing traction aid of claim 13 further comprising the step of inspecting the particles for quality.

15. The method of manufacturing a deicing traction aid of claim 13 wherein drying the product further comprises the step of shaking the product to even the coating and start the drying process.

16. The method of manufacturing a deicing traction aid of claim 13 wherein drying the product further comprises the step of dropping the product to dry it.

17. The method of manufacturing a deicing traction aid of claim 13 wherein drying the product further comprises the step of applying heat to the product.

18. The method of manufacturing a deicing traction aid of claim 13 wherein the amount of coating is adjusted so it adheres to the particles.

19. The method of manufacturing a deicing traction aid of claim 13 further comprising the step of weighing and packaging the product.
